(19) United States
(12) Patent Application Publication
(10) Pub. No.: US 2009/0077995 A1
(43) Pub. Date: Mar. 26, 2009

(54) Refrigerator comprising a water pipe

(75) Inventors: Hans Ihle, Giengen (DE); Wolfgang Kentner, Röfingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 11/918,458

(22) PCT Filed: Mar. 30, 2006
(86) PCT No.: PCT/EP2006/061157

§ 371 Date: Oct. 10, 2007

(30) Foreign Application Priority Data
May 10, 2005 (DE) 10 2005 021 551.3

(51) Int. Cl. B67D 5/62; F25D 19/00

(52) U.S. Cl. 62/389; 62/449

(57) ABSTRACT

A refrigeration device includes a frame and a door that surround a cooling chamber as well as a water pipe that extends inside the frame and the door. A coupling that is separated when the door is open while being connected when the door is closed is disposed between a section of the water pipe extending in the frame and a section of the water pipe extending in the door.

The present invention relates to a refrigeration device having a water supply pipe extending between cabinet and door of the refrigeration device, in particular a refrigeration device wherein a water supply pipe of said kind feeds a dispensing point formed on the door for the purpose of drawing off chilled drinking water.

It is known with refrigeration devices of this type to lead the water supply pipe from the cabinet into the door with the aid of a flexible tube which extends through a protective pipe of a hinge joining the door to the cabinet along the pivotal axis of the hinge.

This technology is only suitable for refrigeration devices in which cabinet and door are connected by means of a single-axle hinge. With multi-link hinges, as used in particular with built-in refrigeration devices in order to guide a door with furniture panel permanently mounted thereto, this solution cannot be used because in general no stationary physical axis of the pivoting movement of the door exists along which the tube could be guided. Although it would be conceivable in principle to guide a tube in the environment of a multi-link hinge freely from the cabinet to the door, a tube of this type needs a lot of space and the risk that the tube will become jammed and get damaged when the door is opened and closed is high.

A general disadvantage of the guiding of a tube via the link between cabinet and door is also that changing the hinge on the door is only possible if the option exists to change the course of the water supply pipe in the cabinet subsequently so that the emergence of the water supply pipe from the cabinet can be adjusted if the door hinge is relocated.

The object of the present invention is therefore to find another solution for guiding a water supply pipe between cabinet and door of a refrigeration device, which solution is subject to no restrictions in terms of the type of hinge used between cabinet and door and allows a compact design of the device.

The object is achieved in that in a refrigeration device comprising a cabinet and a door which enclose a cooling chamber, and having a water supply pipe extending in the cabinet and the door between a section of the water supply pipe running in the cabinet and a section of same running in the door there is disposed a coupling which is separated when the door is open and connected when the door is closed.

In order to prevent water from escaping in the separated state of the coupling, the coupling preferably has a self-closing valve on an upstream side.

Said valve can beneficially have a sealing body which is pressed against a seat and which, when the door is closed, is held away from the seat by means of a projection coupled to the downstream side of the coupling in order thereby to keep the valve open and allow water to flow.

On the downstream side of the coupling there is preferably provided a non-return valve in order to avoid an escape of water at that point also when the coupling is separated.

According to an advantageous development the coupling comprises a pin part and a sleeve part which, with the door closed, are connected by means of a plug-in connection and at least one of which is movable at right angles to the plug-in direction. The movability not only increases the tolerances during the assembly of cabinet and door to one another, but also enables automatic adjustment of the positions of the coupling parts in relation to one another if, whether due to mechanical stress, aging or other causes, the door is displaced in relation to the cabinet at right angles to the direction of its opening and closing movement.

A receiving hole, widened out toward the entry side, for the pin part in the sleeve part facilitates an automatic alignment of the coupling parts in relation to one another when the door is closed if a displacement of the door in relation to the cabinet has occurred.

When the water supply pipe is used in order to feed a dispensing point on the door, an outlet valve of the water supply pipe is beneficially configured at the dispensing point so as to open only with the door closed. This avoids the water being discharged from the section of the water supply pipe running in the door when the door is opened, which, when the door is subsequently closed, would result in the air contained in the pipe being compressed by the pressure of the water and, during a subsequent dispensing action, emerging accompanied by spattering and noise emission.

In order to achieve a coupling of this kind between the valve function and the position of the door, an electric switch is preferably arranged between cabinet and door, said switch being open when the door is open and closed when the door is closed, and the outlet valve is an electrically switched valve which is supplied with operating energy via the switch.

A central arrangement of the coupling between two side walls of the cabinet facilitates changing the hinge of the door, since it is not necessary to adjust the course of the water supply pipe when a hinge is changed.

Further features and advantages of the invention will emerge from the following description of exemplary embodiments with reference to the attached figures, in which:

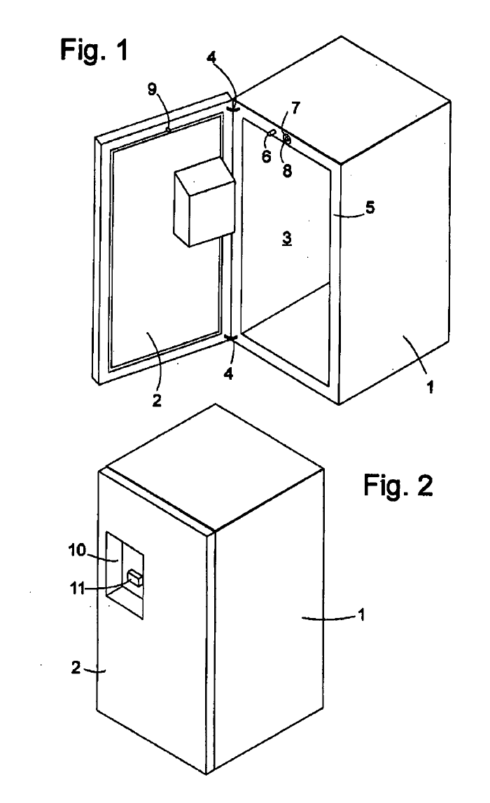

FIG. 1 shows a perspective view of an inventive refrigeration device with the door open;

FIG. 2 shows a view of the refrigeration device with the door closed;

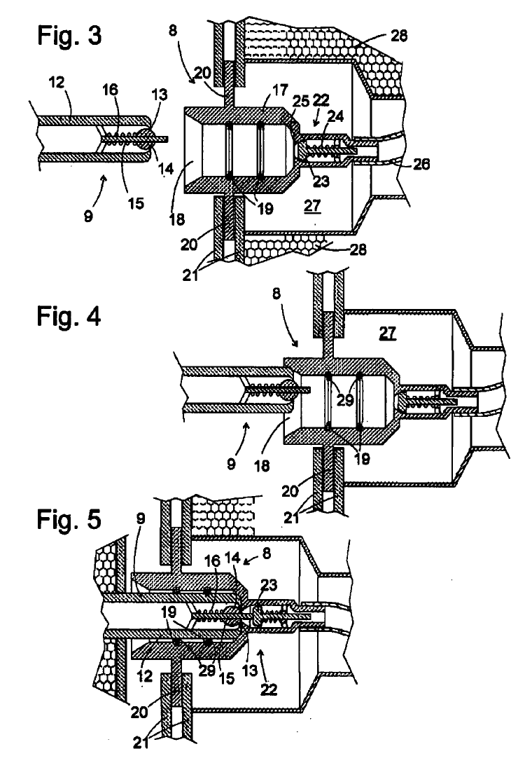

FIG. 3 shows a section through the coupling of the water supply pipe extending in cabinet and door with the door open;

FIG. 4 shows a corresponding section during the closing of the door; and

FIG. 5 shows a section through the coupling with the door closed.

The refrigeration device shown in FIG. 1 has a cabinet 1 and a door 2 which in combination delimit a cooling chamber 3 and are interlinked by means of schematically represented multi-link hinges 4.

Disposed on the top part of the frame 5 of the cabinet 1 facing the door is an electric switch 6, of which a pin which projects above the front of the frame 5 and can be operated through the door 2 can be seen in the figure. The switch 6 switches two contacts, namely one for the interior lighting of the cooling chamber 3, which contact in the known manner is closed when the door 2 is open and open when the door is closed, and a second contact which is open when the door is open and closed when the door is closed.

Arranged in a notch 7, which, like the switch 6, is positioned approximately centrally on the top part of the frame 5, is a sleeve part 8 which forms the downstream end of a section of a water supply pipe running through the wall of the cabinet 1. The sleeve part 8 is provided in order to receive a pin part 9 projecting on the door 2 when the door 2 is closed, which pin part 9 forms the upstream end of a part of the water supply pipe running in the door 2. The water supply pipe extends—not visible in the figure—in the door 2 as far as a recess 10 formed on its front (see FIG. 2). Contained in the recess 10 are an outlet valve (hidden in the perspective view shown in FIG. 2) and a pushbutton switch 11 which can be pressed, e.g. using a beaker held under the outlet valve, in order to open the outlet valve and draw off water. The outlet valve is an electrically actuated valve, e.g. a solenoid-operated valve, which is closed in the currentless state. It is supplied with operating voltage via the second contact of the switch 6 such that it always closes when the door 2 is open, irrespective of an actuation or non-actuation of the pushbutton switch 11, and can only be opened when the door 2 is closed.

FIG. 3 shows an axial section through the sleeve part 8 and the pin part 9 with door 2 open. The pin part 9 comprises a tube section 12 which is narrowed at its inlet end in order to form a valve seat 13 for a valve body 14 which is movably guided on a rod 15. A first end of the rod 15 is anchored in the interior of the tube section 12; the other end projects above the end of the tube section 12. A helical spring 16 slipped onto the rod 15 holds the valve body 14 pressed against the valve seat 13 so that no water can escape from the tube section 12.

The sleeve part 8 is positioned opposite to and not exactly aligned with the tube section 8. The sleeve part has an essentially cylindrical body 17 in which a receiving hole 18 that is widened out in a cone shape toward its entry side is formed to accept the pin part 9. Sealing rings 19 are set into the wall of the receiving hole 18.

A flange 20 projecting annularly from the cylindrical body 17 engages between two parallel walls 21 of the frame 5 and is held between these in a friction-locked but movable manner.

Arranged on the floor of the receiving hole 18 is a self-closing valve 22. It comprises a valve body 23 which is held pressed against a valve seat 25 by means of a helical spring 24. Upstream of the valve 22 a flexible tube 26 is secured to the body 17. Body 17 and tube 26 are accommodated in a cavity 27 which is cut out of an insulating material layer 28 which otherwise fills out the walls of the cabinet 1. The tube 26 forms a movable transition to a rigid tube section (not shown) which is embedded in the insulating material layer 28. When said tube section is connected to an external fresh water supply pipe, the pressure of the fresh water acts on the valve body 23, reinforcing the force of the helical spring 24, and holds the valve body pressed tightly against the seat 25.

FIG. 4 shows a second section through the sleeve part 8 and the pin part 9 at a stage in which these touch each other for the first time during the closing of the door 2. The pin part 9 pushes against the widened cone-shaped inlet area of the receiving hole 18 of the sleeve part 8 and as it moves forward pushes the latter aside so that finally it slides precisely centered into the receiving hole 18.

FIG. 5 shows the pin part 9 inserted into the sleeve part 8 as far as the stop, with the door 2 closed. In this position the valve body 23 of the valve 22 is pressed back by the tip of the rod 15 projecting above the tube section 12, with the result that the valve 22 is open. The inward-directed lips 29 of the sealing rings 19 bent over by the tube section 12 are pressed against the tube section 12 by the water pressure and seal off the coupling toward the outside.

When the outlet valve is opened at the dispensing point, thereby causing the water pressure to drop between the outlet valve and the pin part 9, the valve body 14 is pushed back from the valve seat 13 and fresh water flows through. As soon as the outlet valve is closed, the helical spring 16 presses the valve body 14 back against its seat 13 and the section of the water supply pipe running through the door 2 is closed at both ends.

1-11. (canceled)

12. A refrigeration device comprising:
a.) a cabinet;
b.) a door, the door and the cabinet together delimiting a cooling chamber and the door being selectively openable to permit access to the cooling chamber and closeable to restrict access to the cooling chamber;
c.) a water supply pipe having a section extending in the cabinet and another section extending in the door; and
d.) a coupling, the coupling being disposable between a connected state when the door is closed in which the coupling interconnects the section extending in the cabinet and the other section extending in the door with one another, whereby a supply of water can flow through the section extending in the cabinet, the coupling, and the other section extending in the door, and a separated state when the door is open in which the coupling does not interconnect the section extending in the cabinet and the other section extending in the door.

13. The refrigeration device as claimed in claim 12, wherein the coupling has a self-closing valve on an upstream side.

14. The refrigeration device as claimed in claim 13, wherein the self-closing valve has a sealing body pressed against a seat, the sealing body being held away from the seat by means of a projection coupled to the downstream side of the coupling when the door is closed.

15. The refrigeration device as claimed in claim 12, wherein the coupling has a non-return valve on a downstream side.

16. The refrigeration device as claimed in claim 12, wherein the coupling includes a pin part and a sleeve part that are connected by means of a plug-in connection when the door is closed and at least one of which is movable at right angles to the plug-in direction.

17. The refrigeration device as claimed in claim 16, wherein the sleeve part has a receiving hole that is widened out toward its entry side to receive the pin part.

18. The refrigeration device as claimed in claim 16, wherein the sleeve part has sealing elements that encompass the pin part in a liquid-tight manner in the plugged-in state.

19. The refrigeration device as claimed in claim 16, wherein the pin part is associated with the door and the sleeve part is associated with the cabinet.

20. The refrigeration device as claimed in claim 12 and further comprising a dispensing point formed on the door at which the water supply pipe ends, and an outlet valve of the water supply pipe is configured at the dispensing point so as to open only when the door is closed.

21. The refrigeration device as claimed in claim 20 and further comprising an electric switch that is open when the door is open and closed when the door is closed, and the outlet valve is an electrically switched valve supplied with operating energy via the electric switch.

22. The refrigeration device as claimed in claim 12, wherein the coupling is arranged on the cabinet and on the door centrally between two side walls of the cabinet.
